(19) United States
(12) Patent Application Publication
(10) Pub. No.: US 2010/0236160 A1
(43) Pub. Date: Sep. 23, 2010

(54) WIND POWER MACHINE PROVIDED WITH AN ARTICULATED MAST

(75) Inventors: Philippe Quinet, Jonquieres (FR); Andre Bieber, Adamswiller (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Societe Francaise Des Alizes, Maisons Laffitte (FR)

(21) Appl. No.: 12/303,635

(22) PCT Filed: Jun. 1, 2007
(86) PCT No.: PCT/FR07/00914

§ 371 Date: Dec. 16, 2008

(30) Foreign Application Priority Data
Jun. 7, 2006 (FR) 0605056

(51) Int. Cl. F03D 11/04; E04H 12/18; E04H 12/34; E02D 35/00

(52) U.S. Cl. 52/116; 52/173.1; 52/646; 52/122.1

(57) ABSTRACT

A wind power machine including a mast that is articulated so as to adopt an upright position above a foundation anchored into the ground and a folded-up position close to the ground. The mast includes substantially straight parts articulated together so as to pivot to bring the mast into the upright position or into the folded-up position. The wind power machine further includes a locking device placed at least one of the articulations between two of these parts to lock the mast in the upright position. The locking device includes: a radially movable clamping ring, placed at the end of one of the two parts of the articulation inside the mast; and an actuation mechanism capable of moving the clamping ring radially so as to produce an intimate male/female-type connection between the two parts of the articulation.

The present invention relates to a wind power machine provided with a mast that is articulated so as to adopt an upright position above a foundation anchored in the ground and a folded-up position close to the ground.

Such a mast consists of substantially straight parts articulated to one another so as to be able to pivot between the upright position in which they are substantially aligned vertically and the folded-up position.

In general the wind power machine is arranged in the folded-up position to prevent its being subjected to damage in the event of a strong wind.

A control system is normally provided to ensure that the mast is maintained in the upright position and to co-ordinate the pivoting of the various articulated parts so as to convert the mast from the upright position to the folded-up position, and vice versa.

FR 2823674 A proposes a control system enabling the supporting mast of a wind power machine to be aligned vertically and to be lowered to the horizontal position for maintenance purposes. This control system comprises a lifting mast connected to the supporting mast by cables in the form of stay wires. The lifting mast supports at its end on the ground a winch for winding lifting cables that is activated by the control device so as to be able to lower and lay the wind power machine completely flat on the ground. The supporting mast and the auxiliary mast are articulated at a common point to a base fixed to the ground.

The control system described in FR 2823674 is capable of maintaining the mast in the upright position and of lowering it by operating the cables. However, the handling and manipulation of the cables is dangerous in a strong wind. The winches also occupy a large area around the wind power machine, which limits the installation of equipment and the diameter of the rotor of the pod of the wind power machine.

A wind power machine equipped with a control system for aligning the supporting mast in the vertical position and for lowering it to the horizontal position for purposes of maintenance is likewise known from JP 62282167. The supporting mast of the wind power machine is connected by a cable to a lifting mast and is articulatedly joined to a pedestal. The lifting mast has one end connected to a winch on which the control device acts so as to allow the supporting mast and the lifting mast to tilt from the vertical position to the horizontal position. Such a wind power machine however requires the use of masts of low height. Furthermore, the handling and manipulation of the wind power machine is also very dangerous in a strong wind and the control device occupies a large area around the wind power machine, which limits the installation of equipment.

The present invention aims to obviate the aforementioned disadvantages.

To this end, the invention proposes a wind power machine comprising a mast that is articulated so as to adopt an upright position above a foundation anchored in the ground and a folded-up position close to the ground. The mast is composed of substantially straight parts articulated to one another so as to pivot in order to bring the mast into the upright position or into the folded-up position. The wind power machine also comprises a locking device arranged on at least one of the articulations between two of the said parts so as to clamp the mast in the upright position. The invention envisages that the locking device comprises:
a radially movable clamping ring located at the end of one of the two parts of the said articulation inside the mast, and
actuation means capable of moving the clamping ring radially so as to effect a tight male/female-type connection between the two parts of the articulation.

The clamping of the wind power machine in the upright position accordingly requires no external element or component. The area occupied around the mast is thus reduced. The invention accordingly enables the mast to be clamped in the vertical position without interfering with the devices for pivoting the mast.

The invention also ensures a robust connection between the articulated parts, wherein the clamping or unclamping can be remotely actuated. The technical staff are therefore not exposed to any danger.

According to the invention it is possible to bring the wind power machine into the horizontal folded-up position in a very short time, for example in the case of a storm warning.

Optional, additional or alternative characteristics and features of the invention are disclosed hereinafter:
The clamping ring consists of radially movable portions of rings.
The actuation means comprise hydraulic jacks capable of controlling the radial displacement of two adjacent ring portions.
The hydraulic jacks operate substantially in the radial direction.
The hydraulic jacks extend substantially radially from the axis of the mast, each jack comprising a rod movable along the axis of the jack, and the rod being connected to the two adjacent ring portions associated with the jack.
Each of the two adjacent ring portions is joined to the associated rod of the jack by means of a respective connecting branch, along a pivot connection, the pivoting point on the rod of the two connecting branches being a common point.
The locking device also includes a crosspiece fixed to the end of the rod of each jack, wherein the said crosspiece is capable of being accommodated between the two adjacent ring portions connected to the jack when the mast is clamped.
The crosspiece has a substantially trapezoidal shape, the free edges of the two adjacent ring portions of ring facing one another being bevelled in such a way as to accommodate the crosspiece between them when the mast is clamped.
The locking device comprises three hydraulic jacks arranged substantially at 120° relative to one another, and connected to a common support base located at the centre of the mast.
The wind power machine also comprises at least one main pivoting device capable of co-ordinating the pivoting between a lower part and an upper part, the upper part and the lower part extending substantially horizontally to one another, in the folded-up position of the wind power machine.
The main pivoting device is controlled by a set of parallel hydraulic jacks extending in the transverse plane of the mast.
The mast comprises jack supporting elements arranged at the site of the articulation between the upper part and the lower part, so as to support the said jacks.
The jacks of the main pivoting device each comprise a rod capable of moving along the axis of the jack towards the front of the wind power machine when the jack is compressed.
The main pivoting device comprises two articulated linkages along a horizontal axis perpendicular to the axis of the jacks, the ends of each linkage being fixed on the one hand to the upper part and on the other hand to the lower part of each side of the mast.
The linkages are articulated on a connecting member, the rod of each jack being joined to the said connecting member.
The upper ends of the linkages are joined to one another by a connecting member fixed to the internal wall of the mast, the rod of each jack being joined to one of the articulations of the linkages.
The mast comprises a base part which is fixed and oriented substantially vertically at the end of the wind power machine, the base part being articulated on a lower part of the mast, while the wind power machine comprises an auxiliary pivoting device capable of co-ordinating the pivoting between the lower part of the mast and the base part.
The auxiliary pivoting device comprises a hydraulic jack arranged inside the mast, the jack being connected on the one hand to the base part and on the other hand to the internal wall of the lower part of the mast, at the front of the mast.
The jack comprises a rod movable along the axis of the jack, the jack being connected to the base part at the free end of the rod.
The main pivoting device and the auxiliary pivoting device operate synchronously.

The characteristics and advantages of the invention are disclosed in more detail hereinafter in the following description, with reference to the accompanying drawings, in which:

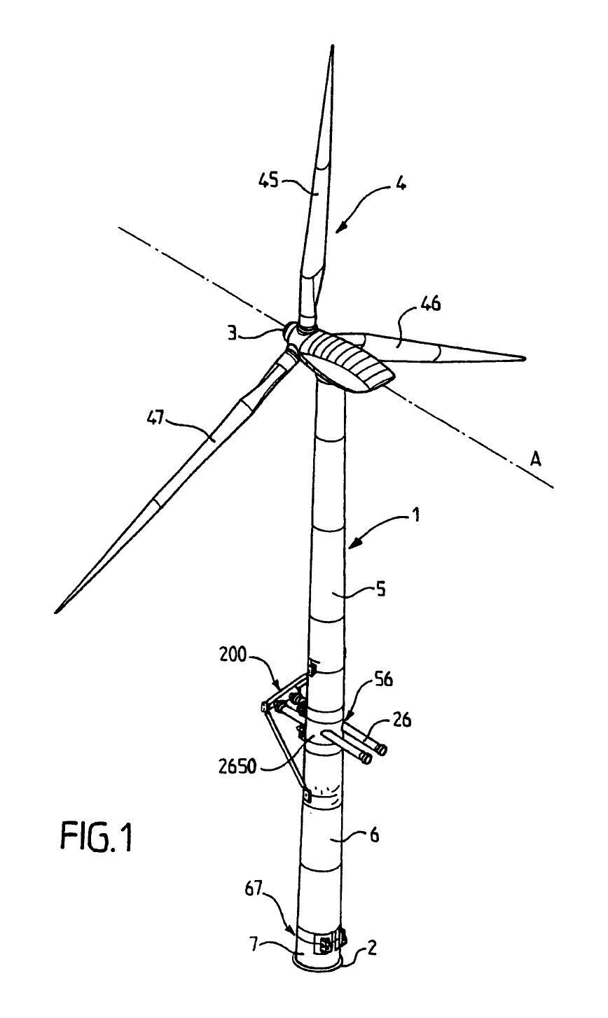

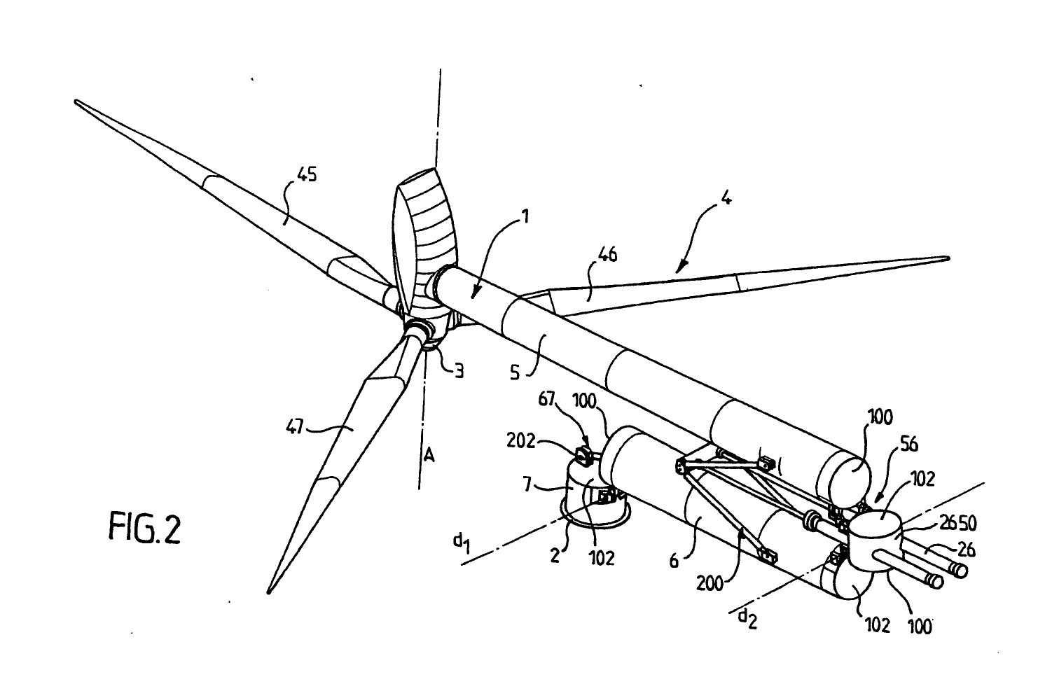

FIGS. 1 and 2 are perspective views of a wind power machine according to the invention in which the mast is respectively in the upright position and in the folded-up position;

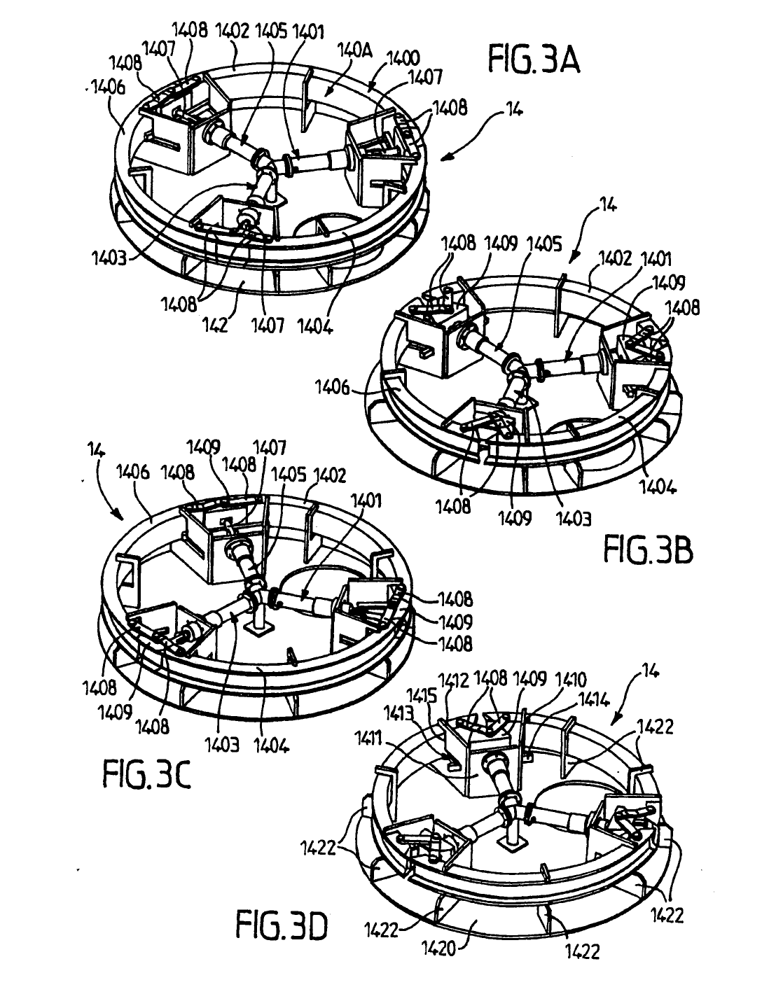

FIGS. 3A to 3D are elevation perspective views of the locking device according to the invention, in different operating states;

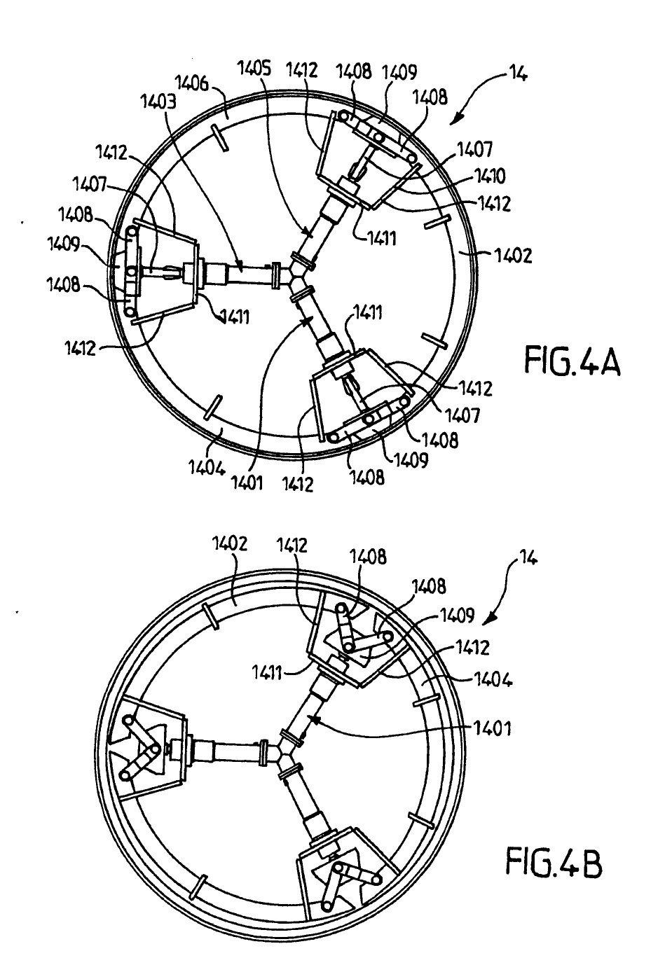

FIGS. 4A and 4B are views from above of the locking device according to the invention, in two different operating states;

FIG. 5 is a flow chart illustrating the various stages involved in bringing the wind power machine to the safety position;

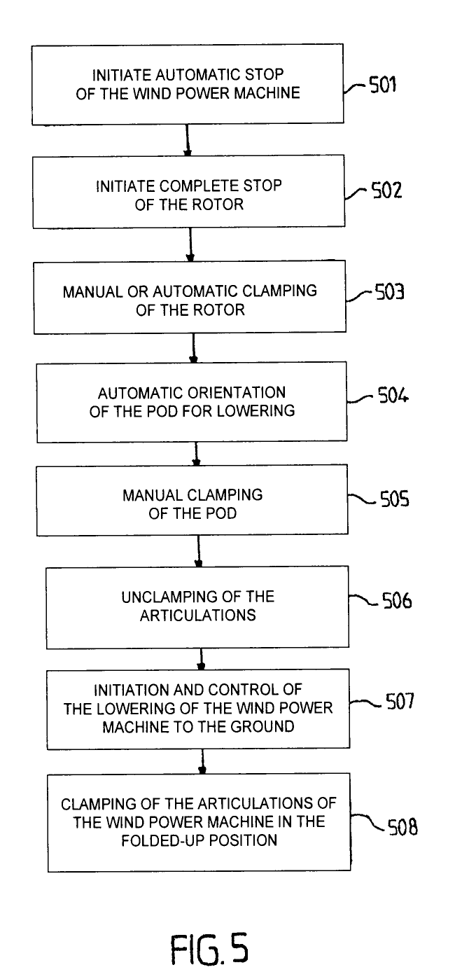

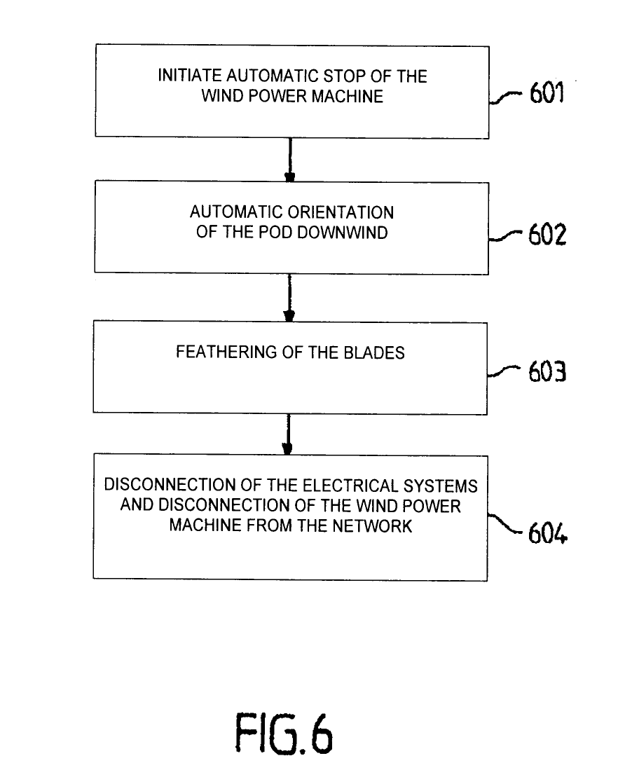

FIG. 6 is a flow chart illustrating the various stages involved in bringing the wind power machine to the emergency position;

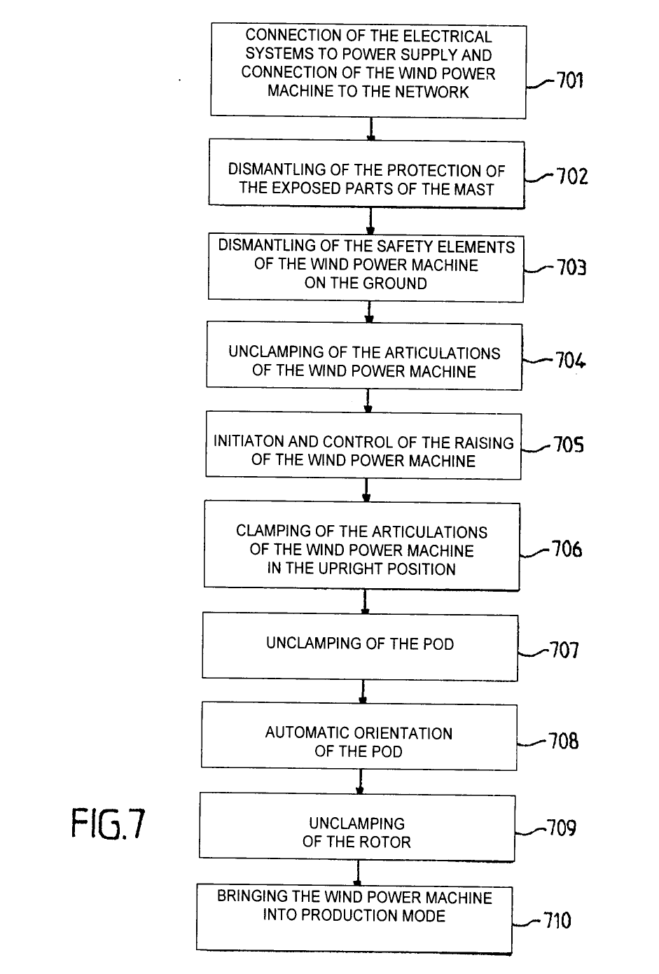

FIG. 7 is a flow chart illustrating the various stages involved in preparing the wind power machine for operation;

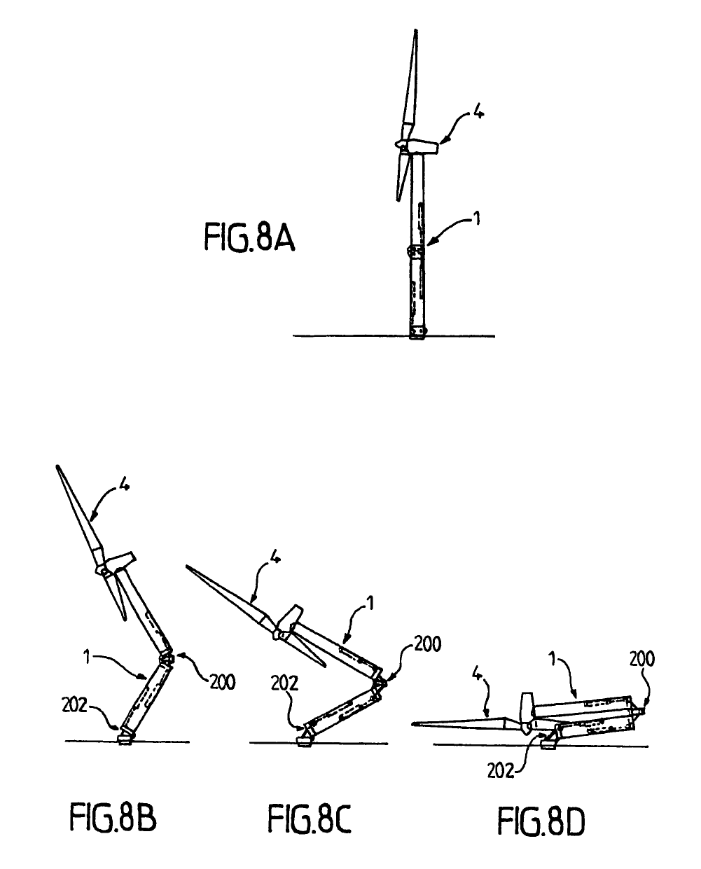

FIGS. 8A to 8D illustrate the various stages involved in folding up the wind power machine;

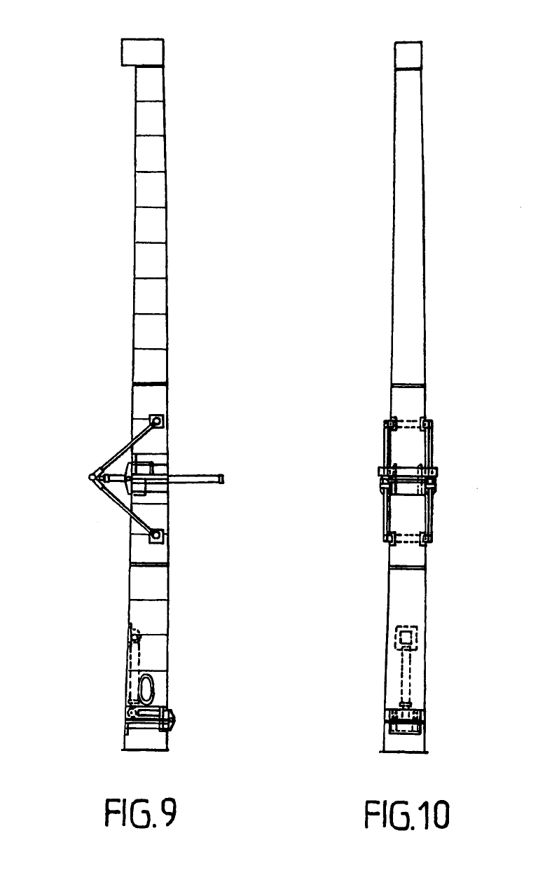

FIGS. 9 and 10 are side and front views of the wind power machine, showing the main and auxiliary pivoting devices, according to a first embodiment of the invention;

FIG. 11 is an exploded view of the wind power machine showing the main and auxiliary pivoting devices, according to the first embodiment of the invention;

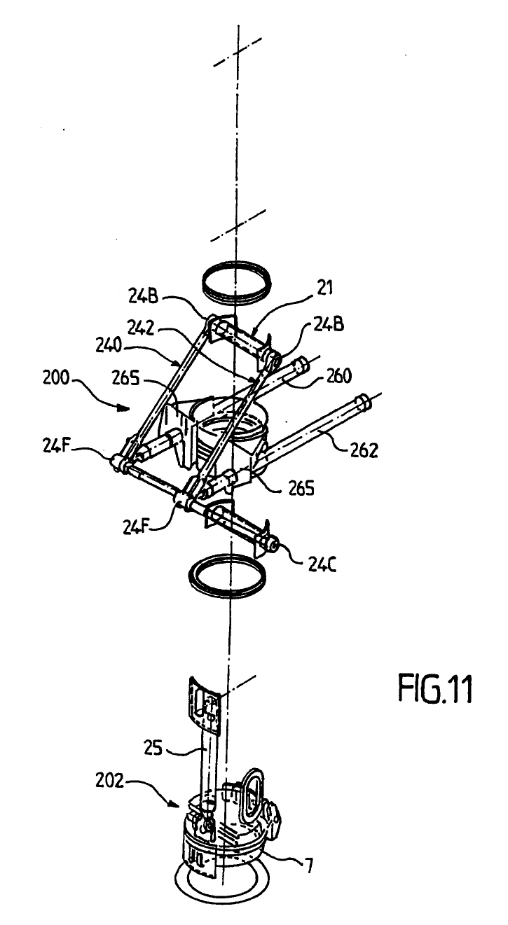

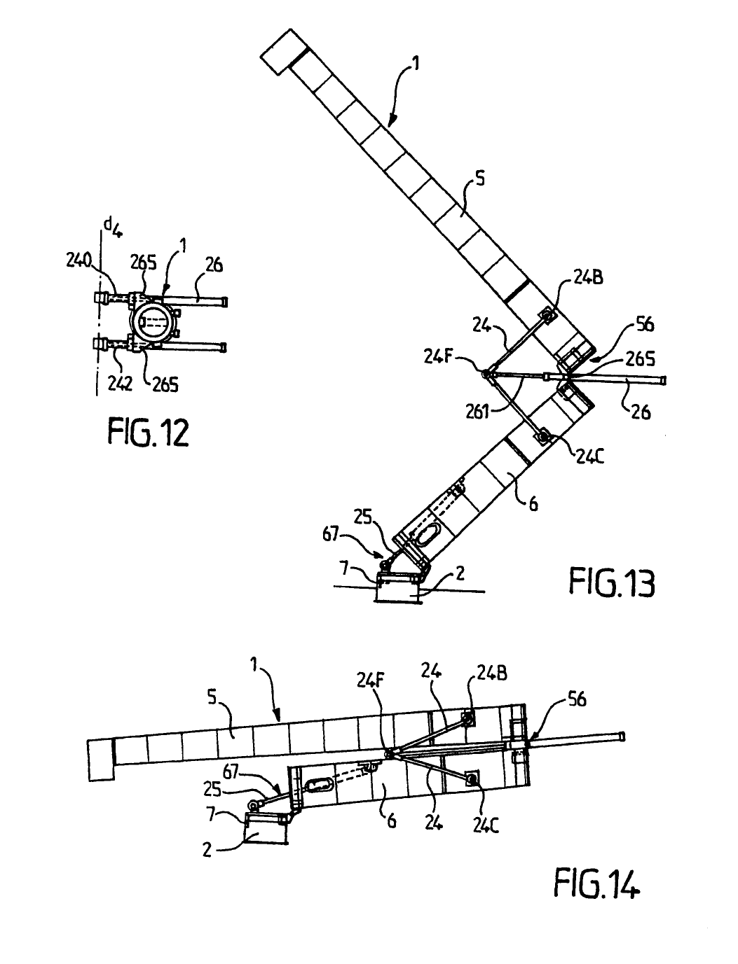

FIG. 12 is a sectional view of the wind power machine at the level of the upper articulation showing the main pivoting device, according to the first embodiment of the invention;

FIG. 13 is a side view of the wind power machine in an intermediate folded position, according to the first embodiment of the invention;

FIG. 14 is a side view of the wind power machine in the folded-up position, according to the first embodiment of the invention;

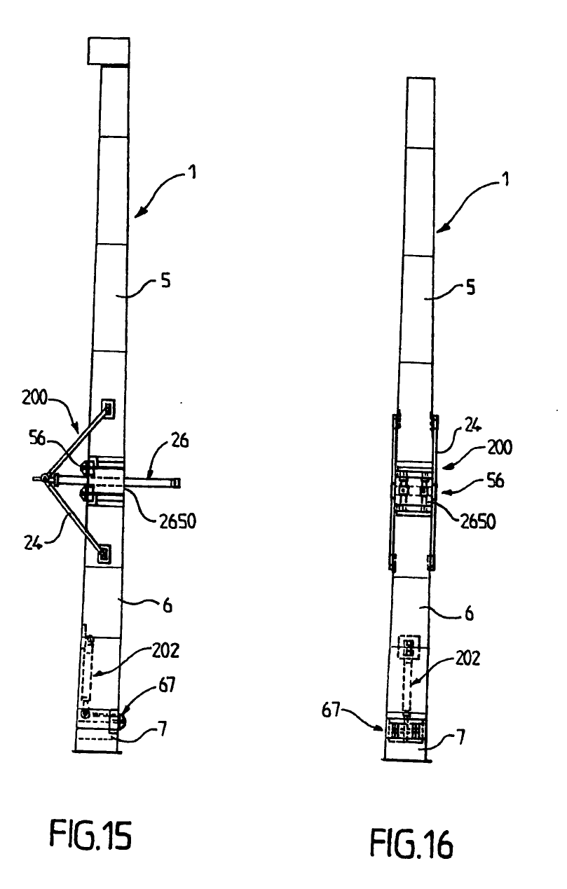

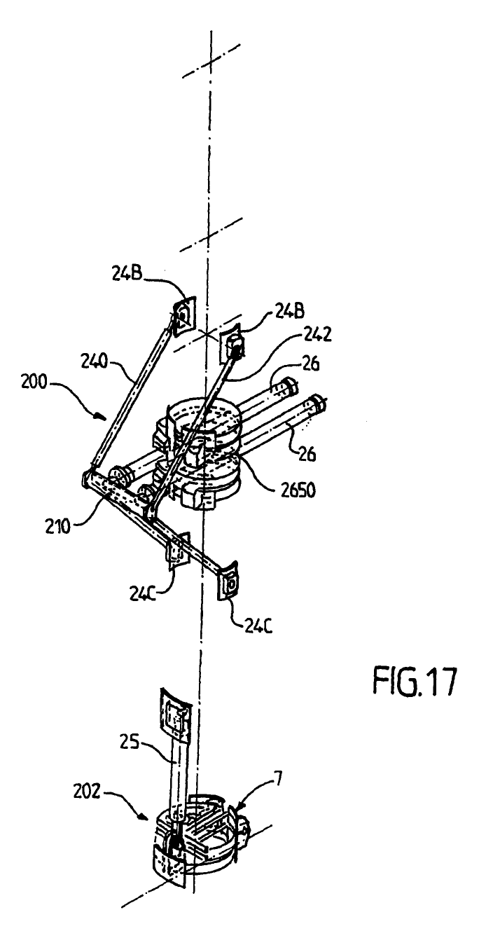

FIGS. 15 to 20 are figures similar to FIGS. 9 to 14, according to a second embodiment of the invention; and

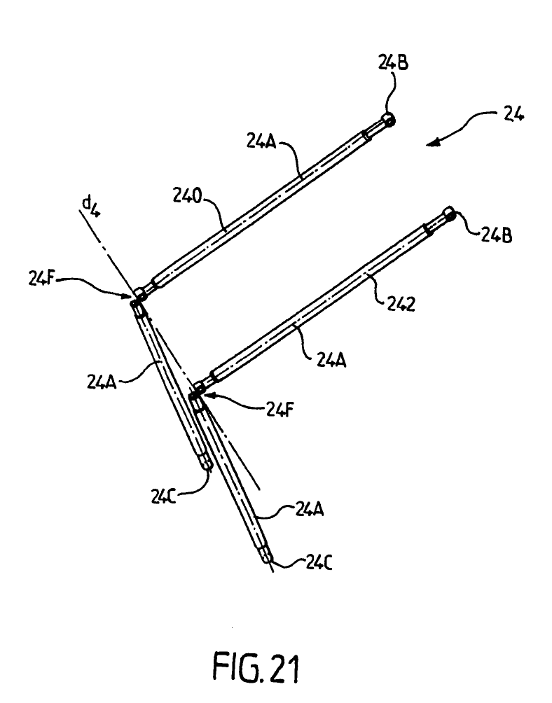

FIG. 21 is a diagram showing the linkages of the upper pivoting system.

The illustrated wind power machine conventionally comprises a base 2 intended to be anchored in the ground, a mast 1, which in the state shown in FIG. 1 rises vertically above the base 2, a support 3, conventionally termed a pod, mounted at the top of the mast and supporting a rotor 4 capable of turning about an approximately horizontal axis A. The illustrated rotor comprises three blades 45, 46, 47 that describe a circle when the rotor turns. The invention will be described with reference to such a rotor. However, other types of rotor are possible, such as for example a rotor with two blades. The base 2 can be in the form of a ring anchored in the ground.

The wind power machine advantageously has an angle of tilt of a few degrees to the horizontal, which allows the blades of the mast to be removed.

An example of an articulated mast of a wind power machine to which the present invention can be applied has been described in French Patent Application No. 0312184. The invention will be described with reference to such a wind power machine, given by way of non-limiting example.

The mast 1 shown in the figures consists of three articulated parts 5, 6 and 7.

The first fixed part 7 or base part, which is integral with the base 2, is articulated around a horizontal axis d1 to a second or lower part 6. The lower part 6 is articulated around a horizontal axis d2 with a third or upper part 5 carrying the pod 3.

In particular, the lower part 6 and upper part 5 are in the form of conical or cylindrical sections of relatively large length, while the base part 7 is in the form of a cylindrical section of small length. Hoops of suitable shape, that is to say conical or cylindrical depending on the particular case, are arranged on the parts 5 to 7 in order to reinforce them.

The invention applies in particular, without however being restricted thereto, to wind power machines in which the mast 1 comprises:
a base part 7 in the form of a cylindrical section 3200 mm in diameter, 2330 mm high and 32 mm thick;
a lower part 6 in the form of a conical section 3200/2800 mm in diameter and 18700 mm high; and
an upper part 5 in the form of a conical section 2800/2050 mm in diameter and 32050 mm high.

The parts 5, 6 and 7 are articulated to one another about horizontal axes d1 and d2, which are parallel to one another and perpendicular to the axis of the rotor A.

Thus, the mast has two articulations, namely an upper articulation 56 and a lower articulation E7 about the horizontal axes d1 and d2. The axis d2 of the articulation 56 is located at the front of the wind power machine, while the axis d1 of the articulation 67 is located at the rear of the wind power machine.

Here and in the following description the expressions “front of the wind power machine” or “rear of the wind power machine”, or also “side of the wind power machine” are used with reference to the orientation of the rotor 4. Thus, “the front” of the wind power machine is situated to the side of the rotor blades.

The base part 7 is fixed and oriented vertically. Each of the other parts 5 and 6, starting from the base part 7, is capable of pivoting in a given direction with respect to the preceding part starting from the upright position of the mast. The pivoting direction is reversed from one articulation to the next.

Reference will now be made to FIG. 2, which shows the wind power machine in the folded-up position. The orientation of the axes d1 and d2 of the articulations 56 and 67 allows the lower part 6 to pivot towards the rear of the wind power machine and the upper part 5 to pivot towards the front of the wind power machine, while the lower connecting surface 100, initially horizontal, of each part 5 and 6 forms an increasingly open angle with the upper connecting surface 102 of the underlying last part 6 and 7.

The invention provides a control system for the wind power machine in order to control the locking of the wind power machine in the upright position, at the level of the articulations, and to control the pivoting of the wind power machine from the upright position (FIG. 1) to the folded-up position (FIG. 2) and vice versa.

The control system comprises a locking device 14 arranged at least one of the articulations 56 and 67 so as to clamp the mast 1 of the wind power machine in the upright position. The locking device 14 is controlled by suitable actuation means. These actuation means can be internal hydraulic jacks in the mast. By way of variation, the locking device 14 can be controlled by means of electrical jacks. The following description is given with reference to a control of the locking device 14 by means of hydraulic jacks given by way of non-limiting example.

The control system also comprises a main pivoting device 200 at the level of the upper articulation 56, and an auxiliary pivoting device 202 at the level of the bottom articulation 67 so as to co-ordinate the pivoting movement of the various parts of the wind power machine. The pivoting of the wind power machine can be effected as far as the position shown in FIG. 2, in which the lower part 6 and upper part 5 extend substantially horizontally for a minimum engagement with the wind, while the bottom part 7 extends substantially vertically. In the example illustrated in FIG. 2 the blades are situated substantially between the upper part 5 and the lower part 6.

The pivoting devices 200 and 202 are controlled by suitable actuation means, in particular by hydraulic jacks 26.

In a first embodiment shown in FIGS. 9 to 14, the jacks 26 of the main pivoting device 200 are supported by support elements 265 arranged at the level of the hinge part of the articulation 56, between the upper part 5 and the lower part 6.

In a second embodiment shown in FIGS. 1, 2, and 15 to 20, a support part 2650 for jacks is provided in order to support the jacks 26 of the main pivoting device 200, between the upper part 5 and the lower part 6.

The control system can also comprise hydraulic control units and an electrical control box equipped with an automation unit allowing the control of the distributors and servo-distributors, the management of the movements of the servo-jacks, as well as the management of the safety systems associated with the hydraulic installation.

Each articulation 56 or 67 is formed by two half-hoops of suitable shape (conical or cylindrical depending on the case) fixed respectively to the two parts on both sides of the articulation. These half-hoops reinforce the ends of the mast sections.

FIGS. 3A to 3D, 4A and 4B are views of a locking device 14 according to the invention.

The following description will be given specifically with reference to the locking device located at the level of the articulation 56 between the upper part 5 and the lower part 6. Of course, such a locking device may be arranged in a similar way at the level of the articulation 67 between the upper part 6 and the base part 7.

The locking device 14 comprises a clamping ring 1400 attached to the end of the lower part 6 on a ring support 142. The wall of the clamping ring 1400 extends into the shaft of the mast, inside the upper part 5, when the mast is assembled.

The locking device also comprises actuation means 1401, 1403 and 1405, capable of displacing the clamping ring radially between two positions so as to force the wall of the clamping ring against the internal wall of the upper part 5 of the mast and thereby effect a tightly clamped male/female-type connection between the upper part 5 and the lower part 6. The clamping ring 1400 grips two half-rings, one fixed to the upper part 5 and the other fixed to the lower part 6.

More particularly, the ring 1400 consists of three ring portions 1402, 1404 and 1406, movable radially between a clamping position and an unclamping position. In the clamping position, shown in FIGS. 3A, 3C and 4A, the diameter of the ring 1400 is substantially equal to the internal diameter of the upper part 5 of the mast, so that the upright mast is clamped in position. In the unclamping position, shown in FIGS. 3B, 3D and 4B, the diameter of the ring 1400 is less than the internal diameter of the upper part 5 of the mast, so that the upright mast is unclamped, for example so that it can be folded up.

The means for actuating the clamping ring comprise three hydraulic jacks 1401, 1403 and 1405, each of which controls the radial movement of two adjacent ring portions. Thus, the jack 1401 acts simultaneously on the ring portions 1402 and 1404, the jack 1403 acts simultaneously on the ring portions 1404 and 1406, while the jack 1405 acts simultaneously on the ring portions 1402 and 1406.

As can be seen in more detail in FIGS. 4A and 4B, each jack 1401, 1403 and 1405 is provided with a radial rod 1407 which simultaneously forces the adjacent ring portions (FIG. 4A) together so as to lock the articulation, or retracts them towards the axis of the mast (FIG. 4B) so as to unlock the articulation.

The rod 1407 of each jack 1401, 1403 and 1405 extends substantially radially from the axis of the mast 1 and can move towards the outside of the mast when the rod is compressed.

Each jack, for example 1401, is furthermore joined to two adjacent ring portions 1402 and 1404 by two connecting branches 1408. One of the ends of each connecting branch 1408 is connected to one of the two adjacent ring portions by means of a pivot link, while the other end of the branches is connected to the hydraulic jack 1401 likewise by means of a pivot link. The two connecting branches 1408 have a common pivoting point on the jack.

Thus, when the hydraulic jacks 1401, 1403 and 1407 are compressed, their rods 1407 are pushed radially towards the outside of the mast 1 in a synchronous manner, so that the two connecting branches 1408 joined to each jack simultaneously separate the two associated adjacent ring portions, 1402/1404, 1404/1406 or 1406/1402, from one another so as to bring the ring 1400 into the clamping position (FIGS. 3A, 3C and 4A). The movement of the three jacks 1401, 1403 and 1405 is synchronised in such a way that the ring portions are always aligned along a circle. In the clamping position, shown for example in FIG. 4A, the two branches 1408 associated with a jack are substantially perpendicular to the rod 1407 of the jack.

When the hydraulic jacks 1401, 1403 and 1407 are disengaged, their rods 1407 move back radially towards the interior of the mast 1 in a synchronous manner, so that the two connecting branches 1408 associated with each jack are brought simultaneously towards the inside of the mast, which produces a radial displacement of the adjacent ring portions (1402/1404, 1404/1406, or 1406/1402) towards the axis of the mast until the ring 1400 reaches the unclamping position (FIGS. 3B, 3D and 4B). In the unclamping position, shown for example in FIG. 4B, the two branches 1408 associated with a jack form between themselves an angle such that the edges of the two adjacent ring portions connected to the branches are brought close to one another.

With reference to FIG. 4B, a crosspiece 1409 can be provided at the free end of the rod 1407 of each jack. Thus, when the rod 1407 of a jack, for example 1401, is forced radially towards the outside, the crosspiece 1409 will move and be located between the two connected adjacent ring portions, 1402 and 1404, in the clamping position (FIG. 4A).

The crosspiece 1409 thus compensates the separation between the adjacent ring portions (1402/1404, 1404/1406, or 1406/1402), which reinforces the clamping of the mast.

Each crosspiece 1409 of a jack, for example 1401, has a shape matching that of the free edges of the two adjacent ring portions 1402 and 1404. In particular, the crosspiece 1409 has a substantially trapezoidal shape while the edges of the two adjacent ring portions, facing one another, are bevelled.

A reinforcing means 1410 may also be associated with each jack 1401, 1403 or 1405 so as to support them. This means 1410 delimits the radial movement of the ring portions 1402, 1404 or 1406 between the clamping position and the unclamping position. In the drawings, each reinforcing means 1410 comprises a transverse wall 1411 arranged upstream of the rod 1407 of the associated jack, for example 1401, and extending perpendicularly to the axis of the jack, as well as two side walls 1412. Each side wall 1412 is joined on one side to the transverse wall 1411. Thus, the reinforcing means 1410 surrounds the end of the rod 1407 of the jack and the junction zone between the two adjacent ring portions 1402 and 1404, while being integral with the fixed part of the jack 1401.

The side walls 1412 of the reinforcing means each have a substantially radial guide groove 1413, while the rod 1407 of the jack 1401 carries a slide bar 1414 perpendicular to the axis of the jack. The slide bar 1414 is configured so that its two ends slide simultaneously in the guide grooves 1413 of the two side walls 1412 during the radial movement of the clamping ring. The side walls 1412 form in particular an obtuse angle with the transverse wall 1411 of the reinforcing means. Thus, in the clamping position, the slide bar 1414 substantially abuts the inner surface of the clamping ring, while in the unclamping position the slide bar 1414 substantially abuts the bottom of the grooves 1413. The reinforcing means 1410 thus allows not only the radial movement of the ring to be delimited, but also enables the locking device to be reinforced and the radial movement of the ring 1400 to be guided.

The end edges of the side walls 1412 that are connected to the clamping ring also have a short section 1415 adapted for the radial displacement of the adjacent ring portions respectively.

As shown in more detail in FIGS. 3A-3D, 4A and 4B, the ring support 142 furthermore comprises a support plate 1420 fixed to the connecting end of the lower part 6 of the mast and a set of support elements 1422 arranged on the circumference of the support plate so as to join the clamping ring 1400 to the lower part 6 of the mast, while permitting the radial displacement of the ring 1400.

Each support element 1422 is substantially U-shaped, the branches of the U extending radially in the direction away from the axis of the mast. The support elements 1422 are more particularly configured so as to allow the radial displacement of the clamping ring 1400. Thus, the clamping ring 1400 will slide between the branches of the U shape during its radial movement.

In the embodiment shown in the drawings, the locking device 14 comprises three hydraulic jacks 1401, 1403 and 1405 arranged substantially at 120° with respect to one another, and connected to a common support base 1424 projecting from the support plate 1420 and extending along the axis of the mast. Of course, the invention is not restricted to this embodiment having three jacks.

The control system can be remotely controlled depending on the external conditions and production requirements.

In particular, the control system of the invention is capable of bringing the wind power machine to the safety position, for example in the case of a strong wind, to the emergency position if the implementation of the safety position is not possible, or also to the production position.

An example of the procedure for implementing the safety position will now be described, with reference to FIG. 5 together with FIG. 8. In FIG. 8 the main pivoting device 200 is supported by a support part 2650 in accordance with the second embodiment of the invention.

The wind power machine is initially in the upright position, as shown in FIG. 8A.

In stage 501 the control system effects an automatic stoppage of the wind power machine by feathering the blades of the pod.

In stage 502 the control system effects a complete stoppage of the rotor in a specific position.

In stage 503 the rotor is manually or automatically clamped in position.

In stage 504 the control system automatically orients the pod in the lowering position.

In stage 505 the pod is manually clamped in position.

In stage 506 the control system actuates the locking devices 14 so as to unclamp the articulates 56 and 67.

In stage 507 the control system actuates the pivoting devices 200 and 202 so as to initiate and control the lowering of the wind power machine to the ground. FIGS. 8A to 8C illustrate the intermediate positions adopted by the wind power machine so that it can be folded up.

In stage 508 the control system acts on the pivoting devices 200 and 202 in order to clamp the articulations 56 and 67 of the wind power machine in the final, completely folded position.

Alternatively, the wind power machine can be made secure manually (blade, pod and articulation attachment pins).

The procedure for implementing the safety position is completed by switching off the electrical systems and disconnecting the wind power machine from the network.

A procedure for implementing the emergency position can also be provided if the operation for implementing the safety position is not possible, for example if the wind speed is already greater than a limiting value of 15 m/sec or if the standby generators are not operational. The procedure for implementing the emergency situation may for example include the stages described below, with reference to FIG. 6.

In stage 601 the control system effects an automatic stoppage of the wind power machine by feathering the blades, the rotor being allowed to rotate freely.

In stage 602 the control system automatically orients the pod in the downwind position, the machine being allowed to rotate freely.

In stage 603 the control system effects a feathering of the blades in the downwind position of the pod.

In stage 604 the control system switches off the electrical systems and disconnects the wind power machine from the network.

An example of the procedure for implementing the production position will now be described with reference to FIG. 7 in conjunction with FIG. 8D. The implementation of the production position is possible only if the wind speed is less than a predefined value, for example 15 m/sec.

In the initial stage the wind power machine is completely folded as shown in FIG. 8D.

In stage 701 the control system connects the electrical systems to the power source and connects the wind power machine to the network.

In stage 702 the protective means for the exposed parts of the mast are dismantled.

In stage 703 the elements for securing the wind power machine to the ground are dismantled (blade, pod and articulation attachment pins).

In stage 704 the control system acts on the pivoting devices 200 and 202 so as to unclamp the articulations 56 and 67 of the wind power machine, which is in the completely folded-up position.

In stage 705 the control system actuates the pivoting devices 200 and 202 so as to initiate and control the raising of the wind power machine.

The wind power machine now changes from the folded-up position shown in FIG. 8D to an upright position as shown in FIG. 8A, passing through the intermediate positions illustrated in FIGS. 8C and 8B.

In stage 706 the control system actuates the locking devices 14 so as to clamp the articulations 56 and 67 of the wind power machine in the upright position.

In stage 707 the pod is manually or automatically unclamped in situ.

In stage 708 the control system automatically orients the pod in position in the direction of the wind.

In stage 709 the rotor is manually or automatically unclamped in situ, following which the hydraulic brake of the rotor is released.

Finally, in stage 710, the wind power machine is automatically brought into production mode.

The control system of the invention is energy-independent when in operation, even in the case of a network failure. The control system thus permits an operation that is completely safe for the technicians and the equipment, including the case of a loss of electrical power or hydraulic or mechanical problems.

The invention also proposes main and auxiliary pivoting devices 200 and 202 controlled by jacks.

The main pivoting device 200 is provided so as to co-ordinate the pivoting between the lower part 6 and the upper part 5, which extend substantially horizontally on top of one another, in the folded-up position of the wind power machine, the auxiliary pivoting device 202 being provided so as to co-ordinate the pivoting between the lower part 6 of the mast and the fixed base part 7.

Reference will now be made to FIGS. 9 and 10, which are respectively a side view and a front view of the mast 1 according to the first embodiment of the invention.

The main pivoting device 200 shown in full lines is arranged at the level of the upper articulation 56 on the outside of the mast, in front of the wind power machine. The main pivoting device 200 comprises hydraulic jacks 26 fixed to the mast at the level of the articulation 56. In the first embodiment the jacks 26 are fixed to support elements 265, arranged in front of the mast, at the level of the articulation 56. The following description will first of all refer to this first embodiment.

The auxiliary pivoting device 202 shown in dotted lines is arranged at the level of the bottom articulation 67 inside the mast, on the front internal wall of the wind power machine.

The main pivoting device 200 and the auxiliary pivoting device 202 can be controlled synchronously.

More specifically, the main pivoting device 200 is arranged on the outside of the mast so as to control the folding of the upper part 5 with respect to the lower part 6, by means of a set of articulated linkages 24 controlled by hydraulic jacks. The auxiliary pivoting device 202 is arranged inside the mast so as to control the folding of the lower part 6 with respect to the base part 7 by means of an internal hydraulic jack.

The main pivoting device 200 will now be described with reference to FIG. 11.

The main pivoting device 200 contains a set of linkages 24 consisting of two linkages 240 and 242 articulated about a horizontal axis, as well as a set of parallel jacks 26 consisting in this case of two jacks 260 and 262 so as to control the movement of the linkages. The axis of the jacks is perpendicular to the axis of articulation d4 of the linkages 24.

The linkages 240 and 242 are mutually symmetrical with respect to a plane passing through the axis of the mast and perpendicular to the plane of the blades of the pod 3. The jacks 260 and 262 have an identical symmetry.

The two jacks 260 and 262 extend in the transverse plane of the mast, outside the mast, and on both sides of its axis. Each jack 260 or 262 has a rod 261 capable of moving along the axis of the jack towards the front of the wind power machine when the jack is compressed.

The jacks 260 and 262 are fixed via the jack support elements 265. In particular, a support element 265 is provided so as to support each jack 260 or 262. These support elements 265 are advantageously fixed to each side of the mast on the upper part 5.

The jacks 26 are joined to the linkages 24 at the site of their articulation 24F. The two linkages 24 are furthermore connected to one another at the level of their upper ends 24B by means of a substantially tubular connecting member 21 which is fixed to the walls of the mast 1, inside the latter. The connecting member 21 is perpendicular to the two jacks and extends in the cross-sectional plane of the mast. The linkages are more specifically connected to the rod of the jacks 260 and 262.

In the second embodiment shown in FIGS. 15 to 17, the jacks 26 are joined to a support part 2650 of the mast provided between the upper part 5 and the lower part 6. The jacks thus pass through the support part 2650 so as to be joined to the linkages 24. The jacks 26 are joined to the linkages 24 by means of a substantially tubular connecting member 210 which defines the axis of articulation d4 of the linkages. The connecting member 210 is perpendicular to the two jacks and extends in the cross-sectional plane of the mast. The connecting member is joined to the rod of the jacks 260 and 262. In this embodiment no additional connecting member is provided between the two upper ends 24B of the linkages. During the folding of the mast 1 the support part 2650 remains substantially vertical.

The linkages are shown in more detail in FIG. 21. Each linkage 240 or 242 consists of two tubes 24A joined to one another at a point of articulation 24F. The upper ends 24B of the linkages 240 or 242 are joined to the upper part 5 of each side of the mast along a pivot link, while the lower ends 24C are joined to the lower part 6 of each side of the mast along a pivot link. Furthermore, the points of articulation 24F of each linkage 240 or 242 are joined either directly to the jacks 26, in the first embodiment of the invention, or to one end of the connecting member 210, also along a pivot link, in the second embodiment of the invention. The two tubes 24A of each linkage 240 or 242 are capable of pivoting towards one another in the folding phase, and in such a way as to move apart when the wind power machine is brought into the upright position. The pivoting of the two linkages is synchronised and is in the same direction.

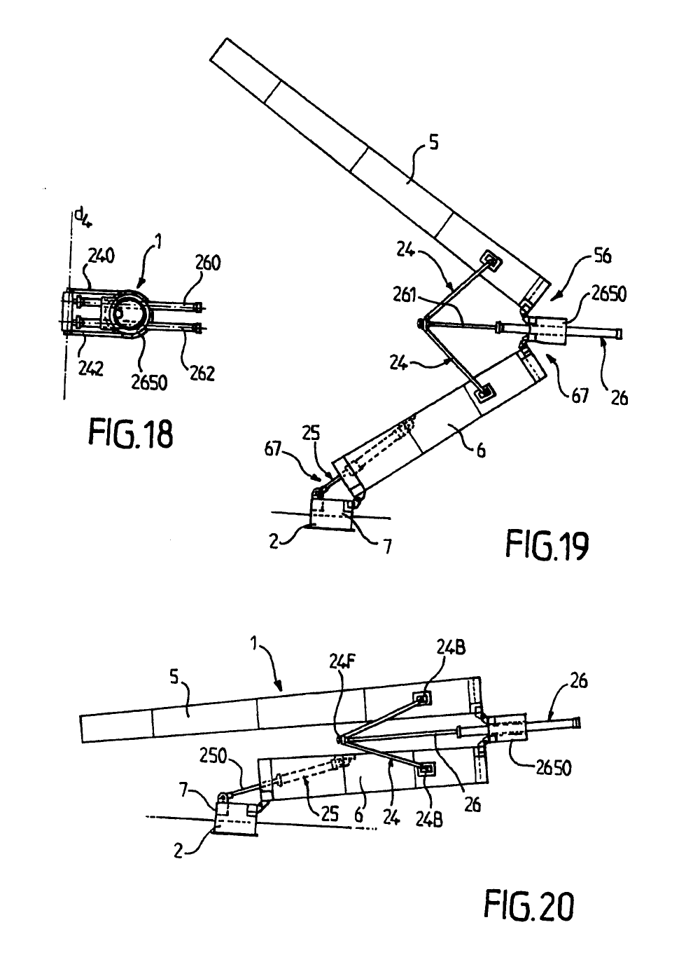

FIGS. 12 and 18 show the position of the jacks 260 and 262 when the wind power machine is in the upright position, in the two embodiments of the invention. In this position the rod 261 of each jack has not emerged.

The two jacks are controlled synchronously so that, when they are compressed, their respective rods 26 force the linkages forwards and cause them to fold. This synchronised folding of the two linkages 240 and 242 progressively draws the lower part 6 and the upper part 5 of the mast towards one another, as shown in FIG. 13, according to the first embodiment of the invention, and as shown in FIG. 19 according to the second embodiment of the invention. This movement is moreover synchronised with the pivoting at the point of articulation 67, which takes place in the opposite direction so as to draw the mast into a substantially horizontal folded-up position, as shown in FIG. 14 according to the first embodiment of the invention, and in FIG. 20 according to the second embodiment of the invention.

The following description is given with reference to the first embodiment, by way of non-limiting example.

The auxiliary pivoting device 202 will now be described with reference to FIG. 11.

The auxiliary pivoting device comprises an articulation jack 25 arranged inside the mast, on the front internal wall of the latter. It is connected on the one hand to the base part 7 of the mast facing opposite the articulation 67, and on the other hand to the internal wall of the lower part 6 of the mast. The jack 25 comprises a rod 250 that can move in the shaft of the jack. The jack 25 is fixed by this rod 250 to the base part 7, as shown in FIGS. 13 and 14. The jack 25 can in particular be a double-action jack, the path of which is controlled by exerting pressure on each side of the jack.

When the auxiliary pivoting device 202 is actuated so as to fold up the mast, the jack 25 is compressed, which forces the rod 250 to the outside of the jack. The length of the jack then increases progressively in such a way as to control the opening angle between the base part 7 and the lower part 6. This movement is synchronised with the movement of the jacks 260 and 262 of the main pivoting device 200, which allows the mast to be folded up in a substantially horizontal position.

When the auxiliary pivoting device 202 is actuated so as to bring the mast into the upright position, the rod 250 is retracted into the jack. The length of the jack then decreases progressively in such a way as to control the decrease in the angle between the base part 7 and the lower part 6. This movement is in this case too synchronised with that of the jacks 260 and 262 of the main pivoting device 200 so as to bring the mast into the upright position.

The movement of the three jacks of the pivoting devices 200 and 202 is controlled according to the constantly increasing rate of displacement so as to follow the range of movements involved in the unfolding and folding up of the wind power machine.

The control system according to the invention enables the mast to be clamped or unclamped in the upright position, and allows the mast to be folded up in a substantially horizontal position in an independent manner, even in the case of severe winds, without any risk to the safety of the technical staff.

The invention is particularly suitable for tall and heavy masts.

The invention also enables the mast to be folded up or brought into the upright position in a relatively short time, which is particularly useful in the case of a storm warning.

Furthermore, the internal locking device of the invention ensures an efficient clamping of the mast without increasing the space occupied around the wind power machine. The locking device is in particular compatible with the installation of the main pivoting device 200.

Certain elements described within the scope of the present invention may be of particular interest and importance when considered separately. This is the case in particular of the main pivoting device 200, or also of the auxiliary pivoting device 202.

The invention is not limited to the embodiments described above. In particular, the invention is not restricted to the shape of the mast shown in the drawings by way of non-limiting examples. Other articulated types of mast are possible, for example a mast having the general shape of a truncated pyramid with a square base.

In addition the locking device 14 of the invention can be arranged on an articulated mast having at least four parts. Moreover, the invention is not restricted just to a locking device 14 provided with three jacks and three clamping ring portions. Other arrangements of jacks and ring portions are possible.

The mast may likewise comprise more than three articulations, the parts being disposed in a zigzag configuration during the folding. In such a variant the mast can have a plurality of main pivoting devices 200 in order to co-ordinate the pivoting between two parts that are folded on top of one another in the horizontal position. Jack support elements 262 are then provided between these two parts.

The invention has been described with reference to a main pivoting device 200 equipped with two jacks 260 and 262. However, the invention also applies to a main pivoting device 200 equipped with one or more than two jacks 26.

More generally, the invention has been described with reference to jack-type actuation means in order to control the pivoting devices 200 and 202, and the locking device 14. However, all types of suitable actuation means can be used in order to control these devices.

1-21. (canceled)

22. A wind power machine comprising:
a mast articulated so as to adopt an upright position above a foundation anchored in the ground and a folded-up position close to the ground, the mast comprising substantially straight parts articulated with one another so as to pivot to bring the mast into the upright position or into the folded-up position;
a locking device arranged on at least one of the articulations between the two parts so as to clamp the mast in the upright position, the locking device comprising:
a radially movable clamping ring arranged at the end of one of the two parts of the articulation inside the mast, and
actuation means for moving the clamping ring radially so as to effect a tight male/female-type connection between the two parts of the articulation.

23. A wind power machine according to claim 22, wherein the clamping ring comprises radially movable ring portions.

24. A wind power machine according to claim 23, wherein the actuation means comprises jacks for controlling radial displacement of two adjacent ring portions.

25. A wind power machine according to claim 24, wherein the jacks of the actuation means are hydraulic jacks.

26. A wind power machine according to claim 25, wherein the hydraulic jacks operate substantially in the radial direction.

27. A wind power machine according to claim 26, wherein the hydraulic jacks extend substantially radially from the axis of the mast and each jack comprises a rod movable along the axis of the jack, the rod being joined to the two adjacent ring portions associated with the jack.

28. A wind power machine according to claim 27, wherein each of the two adjacent ring portions is joined to the rod of the associated jack by a respective connecting branch, along a pivot link, the pivoting point on the rod of the two connecting branches being a common pivoting point.

29. A wind power machine according to claims 27, wherein the locking device further comprises a crosspiece fixed to the end of the rod of each jack, and the crosspiece is configured to be located between the two adjacent ring portions connected to the jack, when the mast is clamped.

30. A wind power machine according to claim 29, wherein the crosspiece is of substantially trapezoidal shape and free edges of two adjacent ring portions facing one another are bevelled so as to accommodate the crosspiece between them when the mast is clamped.

31. A wind power machine according to claim 25, wherein the locking device comprises three hydraulic jacks arranged substantially at 120° relative to one another, connected to a common support base situated at the center of the mast.

32. A wind power machine according to claim 24, further comprising at least one main pivoting device configured to coordinate pivoting between a lower part and an upper part, the upper part and the lower part extending substantially horizontally on top of one another in the folded-up position of the wind power machine.

33. A wind power machine according to claim 32, wherein the main pivoting device is controlled by a set of parallel hydraulic jacks extending in the transverse plane of the mast.

34. A wind power machine according to claim 33, wherein the mast further comprises jack support elements arranged at a point of articulation between the upper part and the lower part, to support the jacks.

35. A wind power machine according to claim 34, wherein the jacks of the main pivoting device each comprise a rod configured to move along the axis of the jack towards the front of the wind power machine, when the jack is compressed.

36. A wind power machine according to claim 35, wherein the main pivoting device comprises two articulated linkages along a horizontal axis perpendicular to the axis of the jacks, the ends of each linkage being fixed to the upper part and to the lower part of each side of the mast.

37. A wind power machine according to claim 36, wherein the linkages are articulated on a connecting member and the rod of each jack is joined to the connecting member.

38. A wind power machine according to claim 36, wherein upper ends of the linkages are joined to one another by a connecting member fixed to the internal wall of the mast, and the rod of each jack is joined to one of the articulations of the linkages.

39. A wind power machine according to claim 32, wherein the mast further comprises a base part fixed and oriented substantially vertically at the end of the wind power machine, the base part being articulated on the lower part of the mast, and comprising an auxiliary pivoting device configured to coordinate the pivoting between the lower part of the mast and the base part.

40. A wind power machine according to claim 39, wherein the auxiliary pivoting device comprises a hydraulic jack arranged inside the mast, the jack being connected to the base part and to the internal wall of the lower part of the mast, at the front of the mast.

41. A wind power machine according to claim 40, wherein the jack comprises a rod movable along the axis of the jack, and the jack is joined to the base part at the free end of the rod.

42. A wind power machine according to claim 38, wherein the main pivoting device and the auxiliary pivoting device operate synchronously.
